(19) United States
(12) Patent Application Publication
(10) Pub. No.: US 2025/0182361 A1
(43) Pub. Date: Jun. 5, 2025

(54) METHOD AND APPARATUS FOR GENERATING EFFECT IMAGE, ELECTRONIC DEVICE, AND STORAGE MEDIUM

(71) Applicant: Beijing Zitiao Network Technology Co., Ltd., Haidian District (CN)

(72) Inventors: Caijin ZHOU, Beijing (CN); Donghao WANG, Beijing (CN); Guohong WU, Beijing (CN); Junlin CHEN, Beijing (CN); Fan ZHANG, Beijing (CN)

(21) Appl. No.: 18/965,896

(22) Filed: Dec. 2, 2024

(30) Foreign Application Priority Data
Dec. 1, 2023 (CN) 202311641123.9

(51) Int. Cl. G06T 11/60; G06F 3/04845; G06F 3/04883

(52) U.S. Cl. CPC G06T 11/60; G06F 3/04845; G06F 3/04883; G06T 2200/24

(57) ABSTRACT

Embodiments of the present disclosure provide a method and an apparatus for generating an effect image, an electronic device, and a storage medium. The method includes: receiving an image to be processed that includes at least one target object; obtaining an image to be used in response to an edit operation from a user for the at least one target object, where the image to be used corresponds to the image to be processed and is an image with the at least one target object deformed; and adding a target material effect to the at least one target object in the image to be used, to generate an effect image corresponding to the image to be processed.

### CROSS-REFERENCE TO RELATED APPLICATION(S)

This application claims priority to Chinese Application No. 202311641123.9 filed on Dec. 1, 2023, the disclosure of which is incorporated herein by reference in its entirety. FIELD

Embodiments of the present disclosure relate to the technical field of effect processing, and in particular, to a method and an apparatus for generating an effect image, an electronic device, and a storage medium.

### BACKGROUND

With the development of network technologies, an increasing number of applications are coming into life of users, especially a range of software applications that can be used to shoot short videos, which are popular among users.

In the prior art, a software developer may add various effect props in an application for a user to use in shooting a video. However, the effect props provided for the user are very limited at present, and the quality of the video and the richness of video content need to be further improved, especially when images are stylized for effect processing or when images are edited, the effect images generated based on the related effect props have a poor display effect.

### SUMMARY

The present disclosure provides a method and an apparatus for generating an effect image, an electronic device, and a storage medium, so that a user can perform customized editing of an effect prop including a deformation effect and a material effect so that the edited effect prop can add a material effect to at least one target object with any deformation and a high-quality effect image can be obtained.

According to a first aspect, an embodiment of the present disclosure provides a method for generating an effect image. The method includes:
receiving an image to be processed that includes at least one target object;
obtaining an image to be used in response to an edit operation from a user for the at least one target object, wherein the image to be used corresponds to the image to be processed and is an image with the at least one target object deformed; and
adding a target material effect to the at least one target object in the image to be used, to generate an effect image corresponding to the image to be processed.

According to a second aspect, an embodiment of the present disclosure further provides an apparatus for generating an effect image. The apparatus includes:
an image receiving module configured to receive an image to be processed that includes at least one target object;
an object editing module configured to obtain an image to be used in response to an edit operation from a user for the at least one target object, where the image to be used corresponds to the image to be processed and is an image with the at least one target object deformed; and
an effect image generating module configured to add a target material effect to the at least one target object in the image to be used, to generate an effect image corresponding to the image to be processed.

According to a third aspect, an embodiment of the present disclosure further provides an electronic device. The electronic device includes:
one or more processors; and
a storage apparatus configured to store one or more programs, wherein
the one or more programs, when executed by the one or more processors, cause the one or more processors to implement the method for generating an effect image described in any one of the embodiments of the present disclosure.

According to a fourth aspect, an embodiment of the present disclosure further provides a storage medium comprising computer-executable instructions, wherein the computer-executable instructions, when executed by a computer processor, are configured to perform the method for generating an effect image described in any one of the embodiments of the present disclosure.

In the technical solutions of the embodiments of the present disclosure, the image to be processed that includes the target object is received. Furthermore, the image to be used is obtained in response to the edit operation from the user for the target object. Finally, the target material effect is added to the target object in the image to be used, to generate the effect image corresponding to the image to be processed.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a method for generating an effect image according to an embodiment of the present disclosure;

FIG. 2 is a schematic flowchart of another method for generating an effect image according to an embodiment of the present disclosure;

FIG. 3 is a schematic diagram of a structure of an apparatus for generating an effect image according to an embodiment of the present disclosure; and

FIG. 4 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further carry a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

Before the technical solutions are described, an exemplary description may be given to the application scenario. The technical solutions can be applied to any scenario where an effect prop needs to be edited and an image needs to be processed based on the edited effect prop so as to obtain an effect image. For example, the effect prop may be a stylized effect prop, which may include deformation stylization and/or material stylization. In order to describe the technical solutions more clearly, the process of executing the technical solutions can be illustrated with an example where the effect prop includes deformation stylization and material stylization. Exemplarily, in the process of editing the effect prop, the effect prop is generally edited based on an editing template corresponding to the effect prop. The combination of a deformation effect and a material effect in the same effect prop is fixed, and editing parameters of the deformation effect and editing parameters of the material effect can be adjusted only within a preset range such that an effect image or video produced based on the effect prop has a simple effect display effect that cannot meet the personalized editing requirements of the user for the effect prop, and thus has some limitations. Further, if the user makes any modification to the editing parameters of the deformation effect to change the deformation effect, the corresponding material effect may result in a poor rendering effect of material rendering of the image on which the deformation effect is presented, or even a failure in material rendering of the image.

In this case, based on the technical solution of this embodiment of the present disclosure, an image to be processed that includes a target object may be received. Then, an image to be used that corresponds to the image to be processed and in which the target object is deformed is obtained in response to an edit operation from a user for the target object. Further, the image to be used may be subjected to material stylization so as to add a target material effect to the target object in the image to be used. Therefore, an effect image that corresponds to the image to be processed and in which the target object is both deformed and added with the target material effect can be generated. In addition, the deformation effect of the target object and the target material effect may be combined together to function as the edited effect prop. Then, in the application process of the effect prop, the effect prop may be called directly, and the image acquired by the user may be processed based on the effect prop, so that the ultimately obtained effect image can present the effect of an effect corresponding to the effect prop.

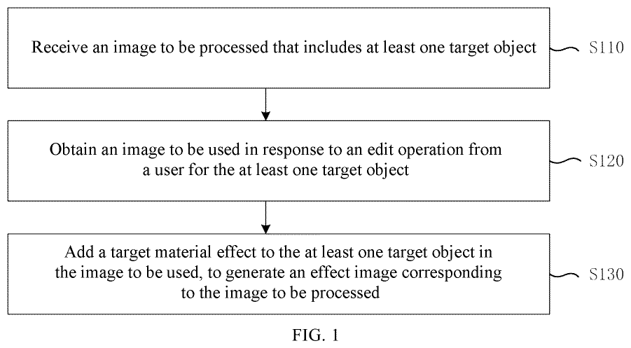

FIG. 1 is a schematic flowchart of a method for generating an effect image according to an embodiment of the present disclosure. This embodiment of the present disclosure is applicable to any case where an effect prop needs to be edited and an effect image is generated in real time based on the edited effect prop. The method may be performed by an apparatus for generating an effect image. The apparatus may be implemented in the form of software and/or hardware, and optionally by an electronic device, which may be a mobile terminal, a PC, a server, or the like.

As shown in FIG. 1, the method in this embodiment may specifically include the following steps.

S110: Receive an image to be processed that includes at least one target object.

In this embodiment, the image to be processed may be understood as an image requiring effect processing. Optionally, the image to be processed may be a default template image, an image acquired based on a terminal device, an image obtained from a target storage space (such as an image library of application software, or a local terminal album) in response to a trigger operation from a user, or an image received from an upload by an external device. The terminal device may refer to an electronic device with an image shooting function, such as a camera, a smart phone, and a tablet computer. Accordingly, the image to be processed may include the target object. The target object may be understood as an object to be subjected to effect processing. The target object may be any type of object included in the image. Optionally, the target object includes a human object and/or an animal object.

It should be noted that the number of target objects included in the image to be processed may be one or more. Regardless of whether it is one or more, the target object can be processed by using the technical solution according to this embodiment of the present disclosure.

In practical application, when effect processing is performed on any image and/or an object in the image, the image to be processed that includes the target object may be received first. Then, the subsequent image processing flow may be continued on the received image to be processed.

It should be noted that the terminal device receiving the image to be processed may be a terminal supporting effect processing on the image, for example, a user terminal registered in application software having an effect processing function; or a user terminal registered in application software with an effect prop production function, which is not specifically limited in the embodiments of the present disclosure.

S120: Obtain an image to be used in response to an edit operation from a user for the at least one target object.

In this embodiment, after the image to be processed that includes the target object is received, the image to be processed may be displayed in an effect processing interface, so that the user can edit the image to be processed. Optionally, the user may be a user of an effect prop application end; or a user of an effect prop production end.

In this embodiment, the target object may be preset to an editable state, so that the user can perform the editing processing on the target object by inputting the edit operation on the target object. The edit operation for the target object may be understood as a series of operations for changing characteristic attributes of the target object that are displayed in the image to be processed, or as operations for changing the object shape of the target object that is displayed in the image to be processed. Optionally, the edit operation may include a touch operation on the target object and/or an operation of inputting a deformation parameter corresponding to the target object. The touch operation may be understood as an operation that directly acts on the target object displayed on the screen. The image to be used is an image obtained after editing the target object included in the image to be processed. The image to be used is an image that corresponds to the image to be processed and in which the target object is deformed. Exemplarily, if the image to be processed is an image including a human face, the target object may be the human face and/or facial features. Upon checking that the user inputs an edit operation of horizontal stretching for the human face, a response may be made to the edit operation, and an image in which the human face in the image to be processed is horizontally stretched may be obtained, which may be used as the image to be used.

In this embodiment, the edit operation for the target object may include an edit operation for at least one part to be edited that corresponds to the target object. The part to be edited is any part of the target object that is displayed in the image to be processed. Optionally, the at least one part to be edited that corresponds to the target object includes a face part, a part of facial features, and a limb part. Exemplarily, if the image to be processed is an image including the face of the user, the part to be edited may be the face part and/or a part of facial features of the user.

Optionally, the obtaining an image to be used in response to an edit operation from a user for the target object includes: obtaining, in response to an edit operation from the user for at least one part to be edited of the target object, an image to be used in which the at least one part to be edited is deformed.

The edit operation includes a touch operation on the at least one part to be edited and/or an operation of inputting a deformation parameter corresponding to the at least one part to be edited.

In this embodiment, the touch operation on the at least one part to be edited may be understood as: an operation acting directly on the part to be edited based on an input device (e.g., a mouse) or a touch point (e.g., a user finger or a stylus). The deformation parameter may be a parameter for indicating the deformation effect that is finally presented by the part to be edited. The deformation parameter may be any value, optionally, 0.1, 0.3, or 0.5, or the like. Exemplarily, if the deformation parameter corresponding to the human face part is 0.3, it may indicate that the deformation degree of the face part is 0.3.

In practical application, there may be at least two methods for generating the image to be used depending on different edit operations on the part to be edited that are input by the user, which are described below.

One method may be as follows. The at least one part to be edited that corresponds to the target object may be preset to a touch-editable state. Then, upon detecting that the user outputs a touch operation for the at least one part to be edited that corresponds to the target object, a response may be made to the touch operation, a point first touched by the user on the corresponding part to be edited is taken as a start point and the start point is controlled to move on the display interface so as to deform the part to be edited. Further, upon detecting that the duration of the pause of this start point in any region on the display interface reaches a preset duration, the position of the pause point at this time may be used as an end point, and at the same time, it may be determined that the touch operation ends. Then, a response may be made to the touch operation, and the image to be used in which the corresponding part to be edited is deformed may be obtained. Exemplarily, if the image to be processed is an image including a human face, the target object may be the human face and/or facial features, and the part to be edited may include a face part and a part of facial features. When a touch operation that is input for the mouth among parts of facial features is detected and this touch operation is a lips curl-up operation, a response may be made to the touch operation, and the image to be used in which the mouth of the target object is deformed may be obtained.

Another method may be as follows. An object editing control may be preset, and deformation parameter editing items corresponding to the parts to be edited may be preset on a parameter editing page. Then, upon detecting a trigger operation on the object editing control by the user, a response is made to the touch operation, where the parameter editing page corresponding to the target object is displayed, so as to enable the user to edit parameters for the deformation parameter editing items displayed in the parameter editing page that correspond to the parts to be edited. Further, upon detecting that the user inputs a corresponding deformation parameter for the editing item corresponding to any part to be edited, the input deformation parameter may be used as the deformation parameter for the corresponding part to be edited. Then, the corresponding part to be edited may be deformed based on the deformation parameter, and the image to be used in which the corresponding part to be edited is deformed may be obtained. Exemplarily, with continued reference to the above example, upon detecting that a deformation parameter corresponding to the face part that is input by the user is 0.3, the human face part may be deformed based on this deformation parameter. Then, the image to be used in which the human face part is deformed may be obtained.

It should be noted that the advantages of obtaining the image to be used based on the above two methods include: the diversity of implementations of the object edit operation is increased, and the flexibility and intelligence of the object edit operation are enhanced, which enriches the interestingness of effect props and further improves the user experience.

S130: Add a target material effect to the at least one target object in the image to be used, to generate an effect image corresponding to the image to be processed.

In this embodiment, the target material effect may be understood as an effect that can change surface attributes of the target object, i.e., an effect that can change a skin texture feature and/or a skin display color of the target object in the image to be used. The target material effect may be any material effect that enables effect processing on the skin or facial features of the target object. Optionally, the target material effect is an effect that simulates the outer skin of an animal or a plant, an effect for the skin of a cartoon character, and/or an effect for the skin of a comic character. In this embodiment, the effect image may be an image that corresponds to the image to be processed and in which the target object is both deformed and added with the target material effect. Exemplarily, if the target material effect is an effect that simulates the outer skin of an animal or a plant, the effect image may be an image in which the skin of the target object that is displayed in the image is the outer skin of the animal or the plant. If the target material effect is an effect for the skin of a cartoon character, the effect image may be an image in which the skin of the target object that is displayed in the image is the skin of the cartoon character. The benefit of such a setting is as follows. In the case of a complex target material effect, the material texture of the target object in the effect image can still present the material effect corresponding to the target material effect.

It should be noted that in practical application, for the user of the effect prop production end, the deformation effect of the target object and the target material effect may be combined together to serve as the edited effect prop, and the effect prop may be uploaded to an effect prop library. Then, for the user of the effect prop application end, the acquired image may be processed directly based on the effect prop, and the target object in the obtained effect image may present the effect of an effect corresponding to the effect prop, i.e., the effect of adding the target material effect on the basis of deformation.

In practical application, after the image to be used is obtained, the image to be used may be processed based on a preset effect addition method, and the target material effect may be added to the target object in the image to be used. Then, the effect image corresponding to the image to be processed is generated. The preset effect addition method may be any method. Optionally, the method may be processing the image based on a generation model corresponding to the target material effect so as to obtain the effect image with the target material effect added to the target object in the image.

Optionally, the adding a target material effect to the target object in the image to be used, to generate an effect image corresponding to the image to be processed includes: inputting the image to be used into a pre-trained material generation effect model to perform a material update of at least one part to be edited in the image to be used based on the material generation effect model, and outputting the effect image with the target material effect added to the target object.

The material generation effect model may be understood as a neural network model that uses an image as an input object to perform a material update of the target object in the image. The material generation effect model may be a generative adversarial network (GAN). In this embodiment, the material generation effect model is trained based on a plurality of pieces of paired data, and each piece of paired data includes input sample data with a target part deformed and output sample data with the target material effect added to the target part. It should be noted that the material generation effect model is in one-to-one correspondence with the target material effect, that is, the material generation effect model corresponding to any target material effect can only output the effect image corresponding to the target material effect.

In practical application, a plurality of target material effects may be pre-determined, and a plurality of pieces of input sample data with the target part deformed differently may be obtained. Further, for various target material effects, each piece of the input sample data may be processed separately based on the current target material effect, and the output sample data with the current target material effect added to the target part may be obtained. Then, the plurality of pieces of paired data corresponding to the current target material effect may be obtained. Further, a neural network model to be trained may be trained based on the plurality of pieces of paired data corresponding to the current target material effect so as to obtain the material generation effect model corresponding to the current target material effect. Then, the material generation effect model corresponding to each target material effect may be obtained. Further, an effect identifier of each target material effect may be obtained, and an association relationship between the effect identifier and the corresponding material generation effect model may be established. Afterwards, each material generation effect model may be deployed at a software terminal of relevant application software.

Further, after the image to be used is obtained and the target material effect is determined, the effect identifier corresponding to the determined target material effect may be obtained. Then, the material generation effect model corresponding to the target material effect may be retrieved based on the effect identifier. Further, the image to be used may be input into the retrieved material generation effect model to perform the material update of the at least one part to be edited that corresponds to the target object included in the image to be used based on the material generation effect model. Then, the effect image with the target material effect added to the target object may be output. The benefit of such a setting is as follows. High-quality materials can be learned based on the generation model, and in the case of off-line rendering, a high-quality material effect can be output based on the trained material generation effect model, thus improving the rendering effect of the material effect.

In the technical solutions of the embodiments of the present disclosure, the image to be processed that includes the target object is received, further, the image to be used is obtained in response to the edit operation from the user for the target object, and finally, the target material effect is added to the target object in the image to be used, to generate the effect image corresponding to the image to be processed. The solution provided in the embodiments of the present disclosure can solve the problem in the related art that an effect prop including a deformation effect and a material effect cannot be edited based on user requirements. Therefore, an effect image or video produced based on the effect prop has a simple effect display effect, which cannot meet the personalized editing requirements of the user for the effect prop. The solution provided in the embodiments of the present disclosure enables the user to perform customized editing on the effect prop including a deformation effect and a material effect. In this way, in the edited effect prop, a material effect can be added to a target object with any deformation. Therefore, a high-quality effect image can be obtained, and the effect display effect of the effect image can be improved. In addition, the interactivity of the user in the use of the effect prop can be enhanced, thereby improving the user experience.

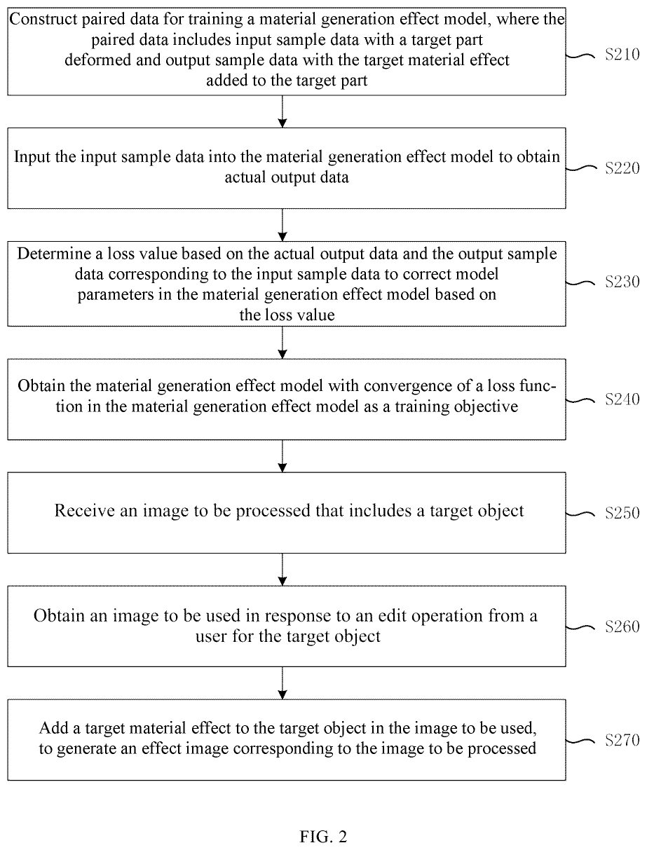

FIG. 2 is a schematic flowchart of another method for generating an effect image according to an embodiment of the present disclosure. On the basis of the above embodiments, the technical solution of this embodiment can construct paired data for training a material generation effect model, and train the material generation effect model based on the constructed paired data so as to obtain the trained material generation effect model. Therefore, the target material effect can be added to the target object in the image based on the material generation effect model, and the corresponding effect image can be obtained. For a specific implementation, reference may be made to the description of this embodiment. Details about technical features that are the same as or similar to those in the foregoing embodiments are not repeated herein.

As shown in FIG. 2, the method in this embodiment may specifically include the following steps.

S210: Construct paired data for training a material generation effect model, where the paired data includes input sample data with a target part deformed and output sample data with the target material effect added to the target part.

In this embodiment, the paired data may be understood as two pieces of data that have a certain association relationship with each other. The target part may be one or more parts included in the target object. The input sample data may be understood as multimedia data with the target part deformed. Optionally, the input sample data may include image data and/or video frame data. The output sample data may be understood as multimedia data output by a desired model corresponding to the input sample data. Accordingly, the output sample data may include image data and/or video frame data. It should be noted that in order to improve the accuracy of the material generation effect model, the number of pieces of the constructed paired data may be a plurality, and each piece of paired data may include the input sample data with the target part deformed and the output sample data with the target material effect added to the target part. In addition, the deformed target parts in the input sample data included in each piece of paired data may be different or the same. In the case where the deformed target parts are the same, the deformation parameters corresponding to the target parts in different pieces of input sample data may be different. Therefore, this may cause each piece of input sample data in the constructed paired data to be distinct sample data.

In practical application, a plurality of training sample images including the target object may be obtained, and corresponding paired data may then be constructed based on the training sample images. Optionally, the constructing paired data for training a material generation effect model includes: obtaining a plurality of training sample images including the target object; deforming, for the training sample images, the target object in the training sample images to obtain input sample data corresponding to the training sample images; processing the input sample data based on a pre-trained diffusion model to obtain output sample data with a material update performed on the target object; and using the input sample data and the output sample data corresponding to the training sample images as the paired data.

In this embodiment, the training sample images may be images captured by a camera apparatus, or images pre-stored in a storage space, or images reconstructed based on an image reconstruction model, or the like. Meanwhile, an image may include one or more objects, and an object in the image may be used as the target object. The diffusion model may be an image generation model that uses an image as an input object to process the image. The diffusion model is a generation model based on iterative denoising, which can generate high-quality and high-resolution images.

In practical application, a plurality of training sample images including the target object may be obtained. Further, for each training sample image, the target object in the training sample image may be deformed based on a preset deformation processing method, and input sample data corresponding to the training sample image may be obtained. It should be noted that in order to enable the finally trained material generation effect model to achieve the addition of the target material effect to target objects with different deformation (e.g., including the cases where the parts to be edited that are deformed are different and/or deformation parameters of the parts to be edited are different), when the input sample data is determined based on the training sample images, a plurality of deformation parameters corresponding to each part to be edited may be preset, and the respective part to be edited may be further deformed separately based on the plurality of deformation parameters, so as to obtain the input sample data.

Optionally, deforming the target object in the training sample images to obtain input sample data corresponding to the training sample images includes: selecting a target deformation parameter set from at least one preset deformation parameter to be selected that corresponds to each part to be edited; and deforming the target object based on the target deformation parameter set to obtain the input sample data.

The target deformation parameter set includes one deformation parameter to be selected that corresponds to each part to be edited. In this embodiment, the deformation parameter to be selected may be any deformation parameter, which may optionally be 0, 0.2, 0.3, or 1, etc.

In practical application, the at least one deformation parameter to be selected that corresponds to each part to be edited may be preset. Then, for each part to be edited, one deformation parameter to be selected may be selected randomly from the at least one deformation parameter to be selected that corresponds to the current part to be edited to serve as the deformation parameter to be selected that corresponds to the current part to be edited. Then, the selected deformation parameter to be selected that corresponds to each part to be edited may be obtained, and the target deformation parameter set may be constructed based on these deformation parameters to be selected. Further, the target object in the training sample images may be deformed based on the target deformation parameter set, so that each corresponding part to be edited in the target object is deformed in accordance with the deformation parameter to be selected that corresponds to the respective part to be edited in the target deformation parameter set. Then, the input sample data may be obtained. It should be noted that if the deformation parameter to be selected that corresponds to any part to be edited in the target deformation parameter set is 0, it may indicate that this part to be edited does not need to be deformed, or, after this part to be edited is deformed, the shape of the deformed part is the same as the shape of the part before the deformation.

Further, after the training sample data is obtained, the input sample data may be input into the pre-trained diffusion model to perform the material update of the target object in the input sample data based on the diffusion model, and the output sample data corresponding to the input sample data is output. Then, the input sample data and the output sample data corresponding to the training sample images may be used as the paired data. The benefit of such a setting is as follows. Diversified deformation data can be constructed, which improves the data volume and richness of the deformation data and provides a data basis for the subsequent training process of the material generation effect model.

S220: Input the input sample data into the material generation effect model to obtain actual output data.

It should be noted that for each piece of paired data, it can be trained in the manner described in S220, thereby obtaining the material generation effect model.

The actual output data may be material-updated effect data that is output after the input sample data is input into the material generation model.

In practical application, after the paired data is obtained, the input sample data in the paired data may be input into the material generation effect model to perform the material update of the at least one part to be edited that corresponds to the target object in the input sample data based on the material generation effect model. Then, the actual output data corresponding to the input sample data may be obtained.

S230: Determine a loss value based on the actual output data and the output sample data corresponding to the input sample data to correct model parameters in the material generation effect model based on the loss value.

The loss value may be understood as a numerical value that characterizes a degree of difference between the actual output data and the output sample data.

In practical application, after the actual output data is obtained, the actual output data may be compared with the output sample data corresponding to the input sample data to determine the loss value. Then, the model parameters in the material generation effect model may be corrected based on the loss value.

S240: Obtain the material generation effect model with convergence of a loss function in the material generation effect model as a training objective.

The loss function may be a function that is determined based on the loss value and is used for characterizing a degree of difference between an actual output and a theoretical output.

In practical application, when the model parameters in the material generation effect model are corrected based on the loss value, a training error of the loss function in the material generation effect model, i.e., a loss parameter, may be used as a condition for detecting whether the current loss function has converged, for example, whether the training error is less than a preset error, or whether an error change tends to stabilize, or whether a current number of model iterations is equal to a preset number, or the like. If it is detected that the convergence condition is satisfied, for example, that the training error of the loss function is less than the preset error or the error change tends to stabilize, it indicates that the training of the current material generation effect model is completed, and at this time, the iterative training may be stopped. If it is detected that the convergence condition is not yet satisfied, input sample data may be further obtained to train the material generation effect model, until the training error of the loss function falls into a preset range. When the training error of the loss function has converged, the current trained model may be used as the material generation effect model.

It should be noted that in the case where there exist a plurality of target material effects, the material generation effect model corresponding to each target material effect can be trained in the above manner to obtain the material generation effect model corresponding to each target material effect.

S250: Receive an image to be processed that includes a target object.

S260: Obtain an image to be used in response to an edit operation from a user for the target object.

S270: Add a target material effect to the target object in the image to be used, to generate an effect image corresponding to the image to be processed.

It should be noted that after the trained material generation effect model is obtained, the image to be processed that includes the target object may be received, and the target object may be deformed to obtain the image to be used. Then, the image to be used in which the target object is deformed is processed based on the material effect generation model to add the target material effect to the target object in the image to be used, to generate the effect image corresponding to the image to be processed. For the specific process of processing the image to be used by the material generation effect model, reference may be made to the descriptions in the above embodiments.

In the technical solution of this embodiment of the present disclosure, the paired data for training the material generation effect model is constructed, where the paired data includes the input sample data with the target part deformed and the output sample data with the target material effect added to the target part, and then the input sample data is input into the material generation effect model to obtain the actual output data, the loss value is determined based on the actual output data and the output sample data corresponding to the input sample data to correct the model parameters in the material generation effect model based on the loss value, and the material generation effect model is obtained with convergence of the loss function in the material generation effect model as the training objective, and further the image to be processed that includes the target object is received, further the image to be used is obtained in response to the edit operation from the user for the target object, and finally the target material effect is added to the target object in the image to be used, to generate the effect image corresponding to the image to be processed. It achieves the effect of being able to construct diversified deformation data, and realizes the effect of training the material generation effect model using the diversified deformation data so that the material generation effect model can process various kinds of deformation inputs and output target material effects, thereby improving the versatility of material effects for diversified deformation data.

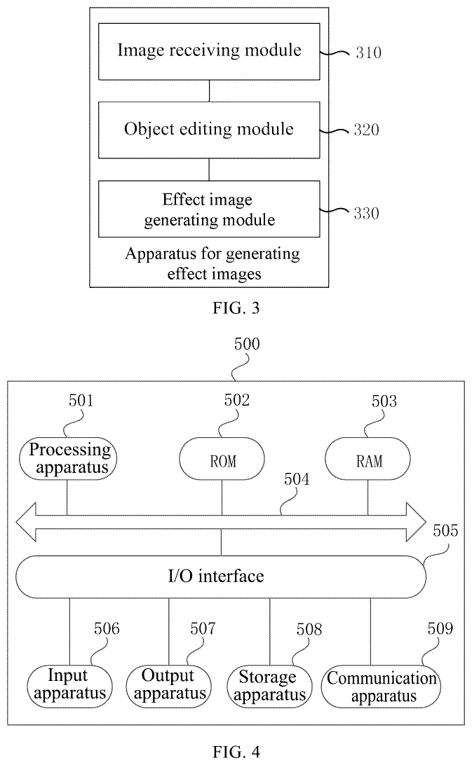

FIG. 3 is a schematic diagram of a structure of an apparatus for generating an effect image according to an embodiment of the present disclosure. As shown in FIG. 3, the apparatus includes: an image receiving module 310, an object editing module 320, and an effect image generating module 330.

The image receiving module 310 is configured to receive an image to be processed that includes a target object; the object editing module 320 is configured to obtain an image to be used in response to an edit operation from a user for the target object, wherein the image to be used corresponds to the image to be processed and is an image with the target object deformed; and the effect image generating module 330 is configured to add a target material effect to the target object in the image to be used, to generate an effect image corresponding to the image to be processed.

On the basis of the above optional technical solutions, optionally, the object editing module 320 is specifically configured to obtain, in response to an edit operation from the user for at least one part to be edited of the target object, the image to be used in which the at least one part to be edited is deformed, wherein the edit operation includes a touch operation on the at least one part to be edited and/or an operation of inputting a deformation parameter corresponding to the at least one part to be edited.

On the basis of the above optional technical solutions, optionally, the effect image generating module 330 is specifically configured to input the image to be used into a pre-trained material generation effect model to perform a material update of at least one part to be edited in the image to be used based on the material generation effect model, and output the effect image with the target material effect added to the target object, wherein the material generation effect model is trained based on a plurality of pieces of paired data, the paired data including input sample data with a target part deformed and output sample data with the target material effect added to the target part, wherein the target part belongs to the at least one part to be edited.

On the basis of the above optional technical solutions, optionally, the apparatus further includes: a paired data constructing module.

The paired data constructing module is configured to construct paired data for training a material generation effect model.

The paired data constructing module includes: a sample image obtaining unit, an object deformation processing unit, an output sample data determining unit, and a paired data constructing unit.

The sample image obtaining unit is configured to obtain a plurality of training sample images including the target object.

The object deformation processing unit is configured to deform, for the training sample images, the target object in the training sample images to obtain input sample data corresponding to the training sample images.

The output sample data determining unit is configured to process the input sample data based on a pre-trained diffusion model to obtain output sample data with a material update performed on the target object.

The paired data constructing unit is configured to use the input sample data and the output sample data corresponding to the training sample images as the paired data.

On the basis of the above optional technical solutions, optionally, the object deformation processing unit includes: a deformation parameter set selecting sub-unit and an object deformation processing sub-unit.

The deformation parameter set selecting sub-unit is configured to select a target deformation parameter set from at least one preset set of deformation parameters to be selected that correspond to each part to be edited, wherein the target deformation parameter set includes one deformation parameter to be selected that corresponds to each part to be edited.

The object deformation processing sub-unit is configured to deform the target object based on the target deformation parameter set to obtain the input sample data.

On the basis of the above optional technical solutions, optionally, the apparatus further includes: an actual output data determining module, a loss value determining module, and a material generation effect model determining module.

The actual output data determining module is configured to input the input sample data into the material generation effect model to obtain actual output data.

The loss value determining module is configured to determine a loss value based on the actual output data and the output sample data corresponding to the input sample data to correct model parameters in the material generation effect model based on the loss value.

The material generation effect model determining module is configured to obtain the material generation effect model with convergence of a loss function in the material generation effect model as a training objective.

On the basis of the above optional technical solutions, optionally, the target object includes a human object and/or an animal object, and at least one part to be edited that corresponds to the target object includes a face part, a part of facial features, and a limb part.

On the basis of the above optional technical solutions, optionally, the target material effect is an effect that simulates the outer skin of an animal or a plant, an effect for the skin of a cartoon character, and/or an effect for the skin of a comic character.

In the technical solutions of the embodiments of the present disclosure, the image to be processed that includes the target object is received, further, the image to be used is obtained in response to the edit operation from the user for the target object, and finally, the target material effect is added to the target object in the image to be used, to generate the effect image corresponding to the image to be processed. The solution provided in the embodiments of the present disclosure can solve the problem in the related art that an effect prop including a deformation effect and a material effect cannot be edited based on user requirements. Therefore, an effect image or video produced based on the effect prop has a simple effect display effect, which cannot meet the personalized editing requirements of the user for the effect prop. The solution provided in the embodiments of the present disclosure enables the user to perform customized editing on the effect prop including a deformation effect and a material effect. In this way, in the edited effect prop, a material effect can be added to a target object with any deformation. Therefore, a high-quality effect image can be obtained, and the effect display effect of the effect image can be improved. In addition, the interactivity of the user in the use of the effect prop can be enhanced, thereby improving the user experience.

The apparatus for generating an effect image according to this embodiment of the present disclosure can perform the method for generating an effect image according to any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

FIG. 4 is a schematic diagram of a structure of an electronic device according to an embodiment of the present disclosure. Reference is made to FIG. 4 below, which is a schematic diagram of a structure of an electronic device (such as a terminal device or a server in FIG. 4) 500 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 4 is merely an example, and shall not impose any limitation on the function and scope of use of the embodiments of the present disclosure.

As shown in FIG. 4, the electronic device 500 may include a processing apparatus (e.g., a central processor or a graphics processor) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 4 shows the electronic device 500 having various apparatuses, it should be understood that it is not required to implement or have all of the shown apparatuses. It may be an alternative to implement or have more or fewer apparatuses.

In particular, according to an embodiment of the present disclosure, the processes described above with reference to the flowcharts may be implemented as a computer software program. For example, an embodiment of the present disclosure includes a computer program product, which includes a computer program carried on a non-transitory computer-readable medium, where the computer program includes program code for performing the method shown in the flowcharts. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiments of the present disclosure are performed.

The names of messages or information exchanged between a plurality of apparatuses in the implementations of the present disclosure are used for illustrative purposes only, and are not used to limit the scope of these messages or information.

The electronic device according to the embodiment of the present disclosure and the method for generating an effect image according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium storing a computer program thereon, where the program, when executed by a processor, causes the method for generating an effect image according to the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as a Hypertext Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: receive an image to be processed that includes a target object;
obtain an image to be used in response to an edit operation from a user for the target object, wherein the image to be used corresponds to the image to be processed and is an image with the target object deformed; and
add a target material effect to the target object in the image to be used, to generate an effect image corresponding to the image to be processed.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagram in the accompanying drawings illustrate the possibly implemented architecture, functions, and operations of the system, method, and computer program product according to various embodiments of the present disclosure. In this regard, each block in the flowcharts or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowcharts, and a combination of the blocks in the block diagram and/or the flowcharts may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/we claim:

1. A method for generating an effect image, comprising:
receiving an image to be processed that comprises at least one target object;
obtaining an image to be used in response to an edit operation from a user for the at least one target object, wherein the image to be used corresponds to the image to be processed and is an image with the at least one target object deformed; and
adding a target material effect to the at least one target object in the image to be used, to generate an effect image corresponding to the image to be processed.

2. The method according to claim 1, wherein the obtaining an image to be used in response to an edit operation from a user for the at least one target object comprises:
obtaining, in response to an edit operation from the user for at least one part to be edited of the at least one target object, an image to be used in which the at least one part to be edited is deformed, and
wherein the edit operation comprises a touch operation on the at least one part to be edited and/or an operation of inputting a deformation parameter corresponding to the at least one part to be edited.

3. The method according to claim 1, wherein adding a target material effect to the at least one target object in the image to be used, to generate an effect image corresponding to the image to be processed comprises:
inputting the image to be used into a pre-trained material generation effect model to perform a material update of at least one part to be edited in the image to be used based on the material generation effect model, and
outputting the effect image with the target material effect added to the at least one target object,
wherein the material generation effect model is trained based on a plurality of pieces of paired data, the paired data comprising input sample data with a target part deformed and output sample data with the target material effect added to the target part.

4. The method according to claim 1, further comprising:
constructing paired data for training a material generation effect model, wherein constructing the paired data for training the material generation effect model comprises:
obtaining a plurality of training sample images comprising the at least one target object;
deforming, for the training sample images, the at least one target object in the training sample images to obtain input sample data corresponding to the training sample images;
processing the input sample data based on a pre-trained diffusion model to obtain output sample data with a material update performed on the at least one target object; and
using the input sample data and the output sample data corresponding to the training sample images as the paired data.

5. The method according to claim 4, wherein the deforming the at least one target object in the training sample images to obtain input sample data corresponding to the training sample images comprises:
selecting a target deformation parameter set from at least one preset set of deformation parameters to be selected that corresponds to each part to be edited, wherein the target deformation parameter set comprises one deformation parameter to be selected that corresponds to each part to be edited; and
deforming the at least one target object based on the target deformation parameter set to obtain the input sample data.

6. The method according to claim 5, further comprising:
inputting the input sample data into the material generation effect model to obtain actual output data;
determining a loss value based on the actual output data and the output sample data corresponding to the input sample data to correct model parameters in the material generation effect model based on the loss value; and
obtaining the material generation effect model with convergence of a loss function in the material generation effect model as a training objective.

7. The method according to claim 1, wherein the at least one target object comprises a human object and/or an animal object, and at least one part to be edited that corresponds to the at least one target object comprises a face part, a part of facial features, and a limb part.

8. The method according to claim 1, wherein the target material effect is an effect that simulates the outer skin of an animal or a plant, an effect for the skin of a cartoon character, and/or an effect for the skin of a comic character.

9. An electronic device, comprising:
one or more processors; and
a storage apparatus configured to store one or more programs, wherein
the one or more programs, when executed by the one or more processors, cause the one or more processors to:
receive an image to be processed that comprises at least one target object;
obtain an image to be used in response to an edit operation from a user for the at least one target object, wherein the image to be used corresponds to the image to be processed and is an image with the at least one target object deformed; and
add a target material effect to the at least one target object in the image to be used, to generate an effect image corresponding to the image to be processed.

10. The electronic device according to claim 9, wherein the one or more programs causing the one or more processors to obtain an image to be used in response to an edit operation from a user for the at least one target object comprise instructions to:
obtain, in response to an edit operation from the user for at least one part to be edited of the at least one target object, an image to be used in which the at least one part to be edited is deformed,
wherein the edit operation comprises a touch operation on the at least one part to be edited and/or an operation of inputting a deformation parameter corresponding to the at least one part to be edited.

11. The electronic device according to claim 9, wherein the one or more programs causing the one or more processors to add a target material effect to the at least one target object in the image to be used, to generate an effect image corresponding to the image to be processed comprise instructions to:
input the image to be used into a pre-trained material generation effect model to perform a material update of at least one part to be edited in the image to be used based on the material generation effect model, and
output the effect image with the target material effect added to the at least one target object,
wherein the material generation effect model is trained based on a plurality of pieces of paired data, the paired data comprising input sample data with a target part deformed and output sample data with the target material effect added to the target part.

12. The electronic device according to claim 9, wherein the one or more programs further comprise instructions to:
construct paired data for training a material generation effect model, wherein constructing the paired data for training the material generation effect model comprises:
obtaining a plurality of training sample images comprising the at least one target object;
deforming, for the training sample images, the at least one target object in the training sample images to obtain input sample data corresponding to the training sample images;
processing the input sample data based on a pre-trained diffusion model to obtain output sample data with a material update performed on the at least one target object; and
using the input sample data and the output sample data corresponding to the training sample images as the paired data.

13. The electronic device according to claim 12, wherein the one or more programs causing the one or more processors to deform the at least one target object in the training sample images to obtain the input sample data corresponding to the training sample images comprise instructions to:
select a target deformation parameter set from at least one set of deformation parameters to be selected that are preset and correspond to each part to be edited, wherein the target deformation parameter set comprises one deformation parameter to be selected that corresponds to each part to be edited; and
deform the at least one target object based on the target deformation parameter set to obtain the input sample data.

14. The electronic device according to claim 13, wherein the one or more programs comprise instructions to:
input the input sample data into the material generation effect model to obtain actual output data;
determine a loss value based on the actual output data and the output sample data corresponding to the input sample data to correct model parameters in the material generation effect model based on the loss value; and
obtain the material generation effect model with convergence of a loss function in the material generation effect model as a training objective.

15. The electronic device according to claim 9, wherein the at least one target object comprises a human object and/or an animal object, and at least one part to be edited that corresponds to the at least one target object comprises a face part, a part of facial features, and a limb part.

16. The electronic device according to claim 9, wherein the target material effect is an effect that simulates the outer skin of an animal or a plant, an effect for the skin of a cartoon character, and/or an effect for the skin of a comic character.

17. A non-transitory storage medium comprising computer-executable instructions, wherein the computer-executable instructions, when executed by a computer processor, cause the computer processor to:
receive an image to be processed that comprises at least one target object;
obtain an image to be used in response to an edit operation from a user for the at least one target object, wherein the image to be used corresponds to the image to be processed and is an image with the at least one target object deformed; and
add a target material effect to the at least one target object in the image to be used, to generate an effect image corresponding to the image to be processed.

18. The non-transitory storage medium according to claim 17, wherein the computer-executable instructions to obtain an image to be used in response to an edit operation from a user for the at least one target object comprise instructions to:
obtain, in response to an edit operation from the user for at least one part to be edited of the at least one target object, an image to be used in which the at least one part to be edited is deformed,
wherein the edit operation comprises a touch operation on the at least one part to be edited and/or an operation of inputting a deformation parameter corresponding to the at least one part to be edited.

19. The non-transitory storage medium according to claim 17, wherein the computer-executable instructions to add a target material effect to the at least one target object in the image to be used, to generate an effect image corresponding to the image to be processed comprise instructions to:
input the image to be used into a pre-trained material generation effect model to perform a material update of at least one part to be edited in the image to be used based on the material generation effect model, and
output the effect image with the target material effect added to the at least one target object,
wherein the material generation effect model is trained based on a plurality of pieces of paired data, the paired data comprising input sample data with a target part deformed and output sample data with the target material effect added to the target part.

20. The non-transitory storage medium according to claim 17, wherein the computer-executable instructions comprise instructions to:
construct paired data for training a material generation effect model, wherein constructing the paired data for training the material generation effect model comprises:
obtaining a plurality of training sample images comprising the at least one target object;
deforming, for the training sample images, the at least one target object in the training sample images to obtain input sample data corresponding to the training sample images;
processing the input sample data based on a pre-trained diffusion model to obtain output sample data with a material update performed on the at least one target object; and
using the input sample data and the output sample data corresponding to the training sample images as the paired data.
